(19) United States
(12) Patent Application Publication
(10) Pub. No.: US 2025/0014166 A1
(43) Pub. Date: Jan. 9, 2025

(54) SYSTEM, IMAGE PROCESSING METHOD, AND PROGRAM

(71) Applicant: HITACHI, LTD., Chiyoda-ku, Tokyo (JP)

(72) Inventors: Naoaki KONDO, Tokyo (JP); Atsushi MIYAMOTO, Tokyo (JP)

(73) Assignee: HITACHI, LTD., Chiyoda-ku, Tokyo (JP)

(21) Appl. No.: 18/712,293

(22) PCT Filed: Oct. 7, 2022
(86) PCT No.: PCT/JP2022/037531

§ 371 Date: May 22, 2024

(30) Foreign Application Priority Data
Dec. 2, 2021 (JP) 2021-196428

(51) Int. Cl. G06T 7/00; G06T 5/50; G06V 10/25

(52) U.S. Cl. CPC G06T 7/0008; G06T 5/50; G06V 10/25; G06T 2207/20221; G06T 2207/20224

(57) ABSTRACT

The present invention can support more appropriate image analysis of an object by carrying out learning to increase the visibility of only a region of interest according to a purpose of image analysis of the object. Provided is a system including at least one processor and at least one memory resource, wherein the memory resource stores a region of interest (ROI) enhancement engine, a learning phase execution program, and an image processing phase execution program, and the processor, by executing the learning phase execution program, uses a learning image obtained by capturing an object for learning to generate an ROI-enhanced learning image in which only the ROI corresponding to an region of interest in a processing image obtained by capturing an object of image processing is enhanced, and, when the learning image is inputted, the processor carries out learning for optimizing internal parameters of the ROI enhancement engine so that the ROI enhancement learning image is generated.

### TECHNICAL FIELD

The present invention relates to a system, an image processing method, and program.

The present invention claims priority of Japanese Patent Application Number 2021-196428 filed on Dec. 2, 2021. Regarding the designated countries where incorporation by reference of documents is permitted, the contents described in the application are incorporated by reference into the present application.

### BACKGROUND ART

For example, in the fields of machinery, materials, food, biotechnology, medicine, etc., observations, appearance inspections, or measurements, etc., are performed by analyzing images obtained by capturing objects. Since it is desirable to use images high in visibility upon the image analysis, there have heretofore been proposed devising by an imaging system such as capturing an object at high solution, and a method of improving visibility.

Further, in recent years, the performance of machine learning has improved dramatically with the proposal of a deep network model, and a method for improving the visibility of an image based on machine learning has been proposed. For example, Patent Literature 1 describes an image estimation method in which “in the image estimation of a system having a storage unit and a calculation unit, the storage unit captures a first image of a first region of a first sample, and a second image of the first region by a microscope and stores the captured images, the calculation unit estimates an estimated processing parameter based on the first image and the second image and acquires a third image captured using a first imaging condition for a desired region of the first sample or the second sample to estimate a fourth image related to a desired region, based on the third image and the estimated processing parameter, and when estimating the estimated processing parameter, the calculation unit obtains the difference between the first image, the estimated image during learning, and the second image as an error, and compares the error with a preset threshold value to determine the opportunity to use the estimated processing parameter during learning as an estimated processing parameter.”

### CITATION LIST

### Patent Literature

### Patent Literature 1

Japanese Unexamined Patent Application Publication No. 2020-113769

### SUMMARY OF INVENTION

### Technical Problem

Patent Literature 1 discloses a parameter learning method for estimating a high-quality image from a degraded image using a pair of an image degraded in image quality and an image high in image quality as learning data. In this learning method, parameters when estimating a high-quality image for the entire degraded image are learned. On the other hand, depending on the purpose of the image analysis, it may be desirable to improve the visibility of only a partial region of interest in an image.

For example, upon observing an object, an image suitable for observation may be obtained by improving the visibility of only a specific portion of the object, or a specific position in the image. Further, when performing an external appearance inspection of an object, it is required to improve the visibility of only a defective portion in order to prevent a non-defective item portion other than a defective portion from being erroneously recognized as detective. In addition, when measuring a specific portion of an object, it may be effective to improve the visibility of only the contour of the portion to be measured. However, the technique described in Patent Literature 1 does not consider improving the visibility of only the region of interest.

The present invention has been made in view of the above problems, and it is an object of the present invention to support more appropriate image analysis of an object by performing learning for improving the visibility of only a region of interest according to the purpose of image analysis of an object.

### Solution to Problem

The present application includes a plurality of measures to solve at least part of the above problems, an example of which is given as follows. A system comprises: at least one processor; and at least one memory resource. The memory resource stores an ROI-enhanced engine, a learning phase execution program, and an image processing phase execution program, and the processor executes the learning phase execution program to generate an ROI-enhanced learning image in which only an ROI (Region Of Interest) corresponding to an interested region of a processed image which is obtained by capturing an object for image processing is enhanced, using a learning image captured of an object for learning. When the learning image is input, the processor performs learning for optimizing an internal parameter of the ROI-enhanced engine so that the ROI-enhanced learning image is generated.

### Advantageous Effects of Invention

According to the present invention, it is possible to support more appropriate image analysis of an object by performing learning for improving the visibility of only a region of interest according to the purpose of image analysis of an object.

### BRIEF DESCRIPTION OF DRAWINGS

FIG. 1 is a view illustrating an example of a schematic configuration of a processor system.

FIG. 2 is a view illustrating an example of a processing sequence of a learning phase and an image processing phase according to a first embodiment.

FIG. 3 is a view for describing a method of designating an ROI using design data of an object.

FIG. 4 is a view illustrating an example of a GUI to designate an ROI, the type of image enhancement processing, and the degree of image enhancement.

FIG. 5 is a view illustrating an example of a processing sequence of performing machine learning on two ROI-enhanced engines.

FIG. 6 is a view illustrating an example of a GUI to designate an ROI, the type of image enhancement processing, and the degree of image enhancement.

FIG. 7 is a view illustrating an example of a processing sequence of a learning phase and an image processing phase according to a second embodiment.

FIG. 8 is a view for describing a method of designating an ROI based on a difference from a reference image.

FIG. 9 is a view illustrating an example of a processing sequence of a learning phase and an image processing phase according to a third embodiment.

FIG. 10 is a view for describing a method of designating an ROI based on a region in which a pseudo defect is combined.

FIG. 11 is a view illustrating a processing sequence related to a non-defective/defective determination as to an object to be inspected using a processed image and an image for comparison.

FIG. 12 is a view illustrating an example of a processing sequence of performing machine learning on two ROI-enhanced engines.

FIG. 13 is a view illustrating a processing sequence related to a non-defective/defective determination as to an object to be inspected using a processed image and an image for comparison.

### DESCRIPTION OF EMBODIMENTS

Respective embodiments of the present invention will be described below with reference to the drawings.

### First Embodiment

A system (processor system) according to the present embodiment is a system which outputs an ROI-enhanced processed image in which only the visibility of an ROI (Region Of Interest) being a predetermined region of interest is improved by performing such image processing that only the ROI is enhanced and displayed on a processed image which is obtained by capturing an object (subject).

The present system performs machine learning of an ROI-enhanced engine so as to generate an ROI-enhanced learning image which enhances only an ROI corresponding to a region of interest in a processed image which is obtained by capturing an object of image processing by using a learning image, and output the ROI-enhanced learning image using the learning image as an input.

Further, the present system outputs an ROI-enhanced processed image in which only the ROI in the processed image is enhanced by inputting the processed image which is obtained by capturing the object into the ROI-enhanced engine.

As a result, according to the present system, it is possible to obtain an image in which only the ROI suitable for the purpose is enhanced.

Note that details of a learning phase in which the ROI-enhanced engine performs machine learning, and an image processing phase in which the ROI-enhanced processed image is output will be described later.

As described above, the ROI refers to a region that a user pays attention to in image analysis, and various regions may apply depending on the purpose of image analysis. The following is an example of the ROI.
(A1): A region which includes patterns that the user wants to detect, such as defects (foreign matter, scratches).
(A2): A region which includes parts and structures that the user wants to recognize, such as shape contours (edges).
(A3): A specific region that the user wants to pay close attention, such as a surface texture.
(A4): A dark region (dark part) or a region with low contrast due to shading, materials, structures, etc.

Note that the ROI is not limited to (A1) to (A4), and any region can be set as an ROI depending on the purpose of use of image analysis or user's designation.

Further, in the learning phase in which the machine learning of the ROI-enhanced engine is performed, it is necessary to specify ROIs in order to generate ROI-enhanced learning images that enhance only the ROIs illustrated in (A1) to (A4) and improve their visibility. On the other hand, since the ROIs differ depending on the user's purpose of analysis, it is necessary to designate to an ROI-enhanced engine 31 what kind of region should be enhanced. Therefore, an example of a method of designating the ROI will be shown below.
(B1) Set by a user using a GUI (Graphical User Interface) or the like.
(B2) Take a difference using a reference image and set based on a difference value.
(B3) Set based on divided regions obtained by image segmentation.
(B4) Acquire a correspondence relationship by matching design data of an object with an image, and set based on a region set on the design data.
(B5) Set based on a region to which image processing is applied.

Note that the ROI designation method is not limited to (B1) to (B5), and the ROI can be designated in various ways including automatic and manual methods.

Further, (B1), (B2), (B4), and (B5) will be described in detail in each embodiment below. Note that the designation method of (B3) is a method of designating an ROI for each divided region, for example, when an object illustrated in a learning image can be divided into a plurality of parts. Further, the designation method of (B3) also includes, for example, a method for dividing the learning image into a plurality of equal parts and designating the divided region among them as the ROI.

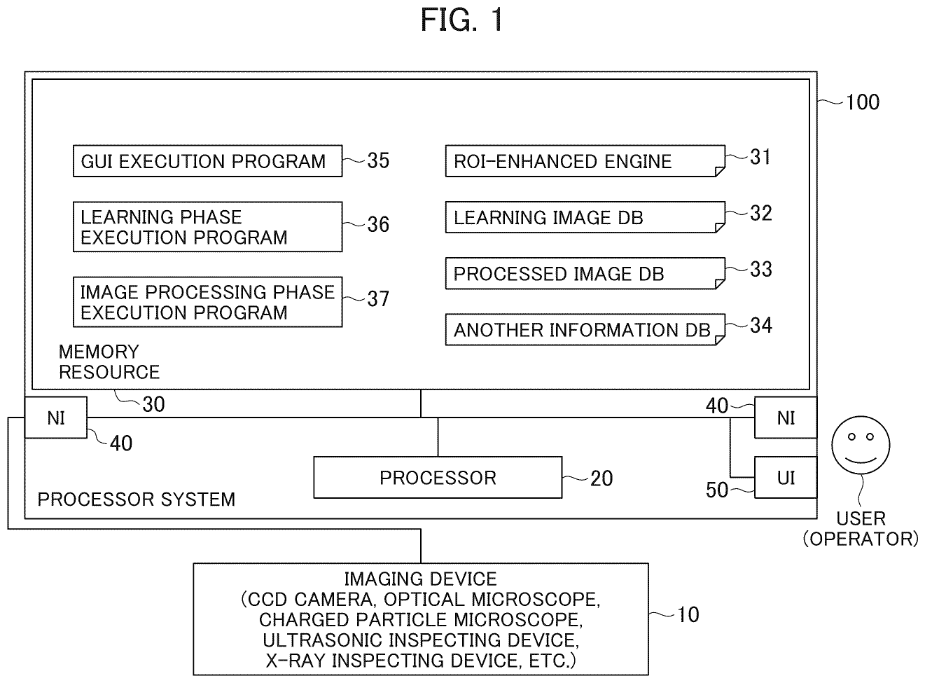

Hereinafter, a detail of processing in accordance with configurations and embodiments of the present system is described with reference to FIG. 1 to FIG. 6.

### <Configuration of Processor System (Present System) 100>

FIG. 1 is a view illustrating an example of a schematic configuration of a processor system 100.

As illustrated in the figure, the present system 100 is connected to an imaging device 10 by, for example, a communication cable, or a predetermined communication network (e.g., Internet, a LAN (Local Area Network), or a WAN (Wide Area Network), or the like) in a mutually communicable manner.

### <<Details of Imaging Device 10>>

The imaging device 10 is an imaging device 10 capable of capturing a digital image or digital video on the surface of an object (subject) or thereinside. Specifically, the imaging device 10 is a CCD (Charge Coupled Device) camera, an optical microscope, a charged particle microscope, an ultrasonic inspecting device, and an X-ray inspecting device, etc. The imaging device 10 captures an object and outputs (or transmits) a captured image to the processor system 100. Note that a plurality of the imaging devices 10 may be connected to the present system 100.

### <<Details of Processor System 100>>

The processor system 100 executes processing of the learning phase and the image processing phase by having a processor 20 read various programs stored in a memory resource.

Note that the processor system 100 is a computer such as a personal computer, a tablet terminal, a smartphone, a server computer, and a cloud server, etc. and is a system which includes at least one or more of these computers.

Specifically, the processor system 100 includes a processor 20, a memory resource 30, an NI (Network Interface Device) 40, and a UI (User Interface Device) 50.

The processor 20 is an arithmetic device which reads the various programs stored in the memory resource 30 and executes processing corresponding to each program. Note that examples of the processor 20 include a microprocessor, a CPU (Central Processing Unit), a GPU (Graphics Processing Unit), an FPGA (Field Programmable Gate Array), or other semiconductor devices that can perform calculations, etc.

The memory resource 30 is a storage device which stores various information therein. Specifically, the memory resource 30 is, for example, a non-volatile or volatile storage medium such as a RAM (Random Access Memory), a ROM (Read Only Memory), or the like. Note that the memory resource may be, for example, a rewritable storage medium such as a flash memory, a hard disk, or an SSD (Solid State Drive), a USB (UNI40versal Serial Bus) memory, a memory card, and a hard disk.

The NI 40 is a communication device which performs information communication with an external device. The NI 40 performs information communication with an external device (e.g., the imaging device 10) via a predetermined communication network such as a LAN, Internet, or the like. Note that unless otherwise mentioned below, it is assumed that information communication between the processor system 100 and the imaging device 10 is executed via the NI 40.

The UI 50 is an input device which outputs a user's (operator's) instruction to the processor system 100, and an output device which outputs information or the like generated by the processor system 100. The input device includes, for example, a keyboard, a touch panel, a pointing device such as a mouse, an audio input device like a microphone, etc.

Further, the output device includes, for example, a display, a printer, a voice synthesizer, etc. Note that unless otherwise mentioned below, it is assumed that user's operations on the processor system 100 (for example, information input, output, and processing execution instructions, etc.) are executed via the UI 50.

Also, some or all of the respective configurations, functions, processing measures, etc. of the present system 100 may be realized in hardware by, for example, designing with integrated circuits, etc. Further, in the present system 100, some or all of the functions can also be realized by software, or can also be realized by cooperation between software and hardware. In addition, the present system 100 may use hardware having a stationary circuit, or may use hardware which allows at least part of a circuit to be changed.

Furthermore, the present system 100 can also be realized by a user (operator) implementing part or all of the functions and processing realized by each program.

Note that each DB (database) in the memory resource 30 to be described below may be a file or the like or a data structure other than a database as long as it is a region in which data can be stored.

### <<ROI-Enhanced Engine 31>>

The ROI-enhanced engine 31 is, for example, a deep neural network represented by a CNN (Convolutional Neural Network). Note that the ROI-enhanced engine 31 is not limited to a machine learning type deep neural network, but can also use a rule-based engine, for example.

The ROI-enhanced engine 31 performs machine learning in the learning phase. Specifically, when a learning image is input, the ROI-enhanced engine 31 optimizes internal parameters so as to output an ROI-enhanced learning image in which image enhancement processing (e.g., contrast enhancement processing, histogram flattening processing, and contour enhancement processing, etc.) is performed only on a designated ROI of the learning image.

Further, in the image processing phase, when a captured image of an object (hereinafter may be referred to as a processed image) is input, the ROI-enhanced engine 31 generates an ROI-enhanced processed image in which only the ROI is enhanced, and outputs the same.

Note that when using a neural network in the ROI-enhanced engine 31, the internal parameters of such an engine include, for example, a network structure of the neural network, an activation function, hyperparameters such as a learning rate, learning termination conditions, etc., model parameters such as weights (coupling coefficients) between nodes and biases of a network, etc.

Further, when the rule-based engine is used in the ROI-enhanced engine 31, the internal parameters of such an engine include image processing parameters such as filter coefficients and determination threshold values for various kinds of image processing.

Note that in the ROI-enhanced engine 31, the machine learning type engine and the rule-based engine may be used in combination.

### <<Learning Image DB 32>>

The learning image DB 32 is a database in which learning images used in the machine learning in the learning phase are stored. The learning image DB 32 may store the learning image in advance, or when the learning image is captured by the imaging device 10 during the learning phase, the learning image DB 32 may store such a learning image.

### <<Processed Image DB 33>>

The processed image DB 33 is a database which stores the processed image of the object imaged by the imaging device 10 during execution of the image processing phase.

### <<Another Information DB 34>>

Another information DB 34 is a database which stores various information used in the learning phase and the image processing phase. For example, another information DB 34 stores the design data of the object used in the ROI designation method (B4). Further, another information DB 34 stores information related to the pseudo defects used in the ROI designation method (B5), for example.

### <<GUI Execution Program 35>>

The GUI execution program 35 is a program which generates predetermined screen information to be output to the UI 50 (in this case, a display) and receives the input of information, processing execution instructions, etc. from the user via the UI 50 (in this case, a pointing device such as a keyboard or a mouse). Specifically, the GUI execution program 35 generates screen information which accepts ROI designation, etc., and outputs the same to the display. Further, the GUI execution program 35 accepts ROI designation and other information input from the user via the UI 50.

### <<Learning Phase Execution Program 36>>

The learning phase execution program 36 is a program which executes various processing in the learning phase. Specifically, the learning phase execution program 36 acquires a learning image from the learning image DB 32 and generates an ROI-enhanced learning image in which image enhancement processing is performed only on the ROI. Further, the learning phase execution program 36 inputs a learning image to the ROI-enhanced engine 31 and performs machine learning of the ROI-enhanced engine 31 so that an ROI-enhanced learning image is output.

### <<Image Processing Phase Execution Program 37>>

The image processing phase execution program 37 is a program which executes various processing related to the image processing phase. Specifically, the image processing phase execution program 37 acquires a processed image of the object from the processed image DB 33, and inputs the image to the ROI-enhanced engine 31, to thereby acquire ROI-enhanced processed image in which only the ROI is enhanced.

The details of the processor system 100 have been described above.

### <Details of Learning Phase and Image Processing Phase>

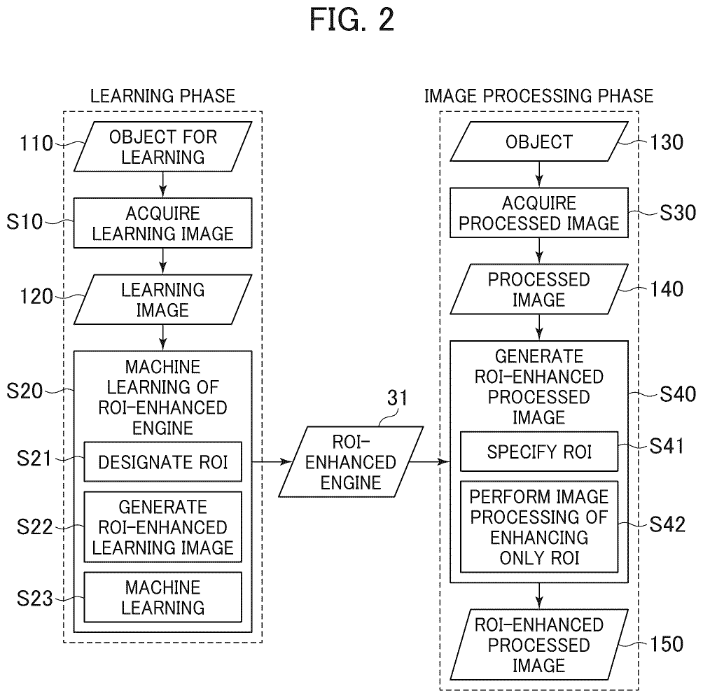

FIG. 2 is a view illustrating an example of a processing sequence of a learning phase and an image processing phase.

In the learning phase, the machine learning of the ROI-enhanced engine 31 is performed. Note that, for example, in the case where a user instructs the processor system 100 to execute the learning phase via the UI 50, etc., the learning phase is started at a predetermined timing.

When the learning phase is started, the processor system 100 executes the learning phase execution program 36. The learning phase execution program 36 acquires a learning image 120 which is obtained by capturing an object 110 for learning from the learning image DB 32 (Step S10). Note that the learning phase execution program 36 may output an instruction to capture the learning image 120 of the learning object 110 to the imaging device 10 via the NI 40 and acquire the learning image 120 of the object imaged by the imaging device 10 from the learning image DB 32.

Next, the learning phase execution program 36 executes the machine learning of the ROI-enhanced engine 31 (Step S20) Specifically, the learning phase execution program 36 designates an ROI (Step S21).

Here, regarding the designation of the ROI, description will be made about a method using design data of an object given by CAD (Computer-Aided Design) or the like (ROI designation method corresponding to B4 described above).

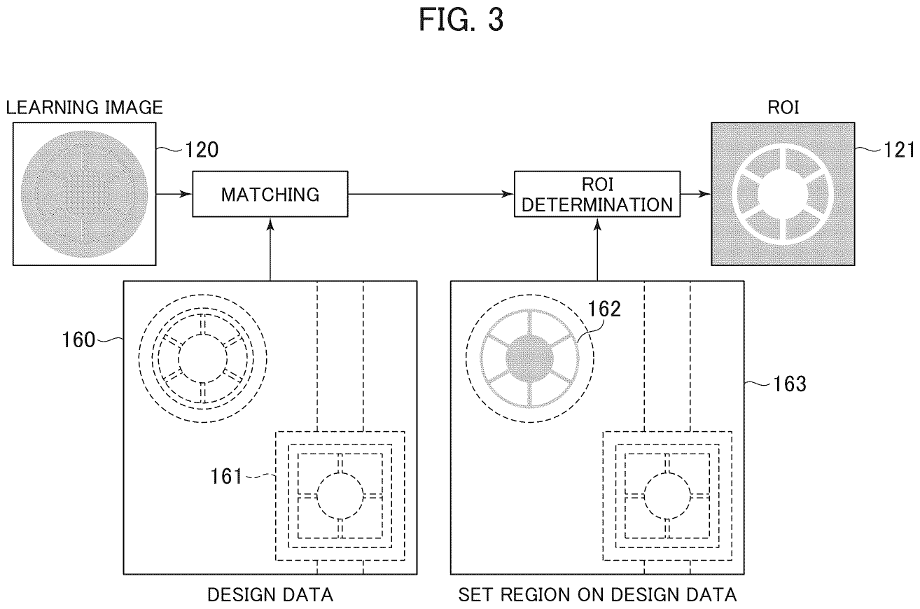

FIG. 3 is a view for describing a method of designating an ROI using design data of an object. The present method matches a learning image 120 and design data 160 with each other and designates a region 162 in which the learning image 120 is matched with a set region on the design data 160 as an ROI 121.

Specifically, the learning phase execution program 36 acquires design data of an object from another information DB 34, for example. Note that a broken line 161 of the design data illustrated in the figure indicates a contour line of a design shape of the object.

Further, the learning phase execution program 36 matches the learning image 120 on the design data 160, based on each feature point between the design data and the learning image 120. Then, the learning phase execution program 36 determines as an ROI 121, a region (the region 162 in which the learning image 120 is matched in FIG. 3) on the design data 160 with which the learning image 120 is matched, and designates such a region 162 as the ROI 121.

Next, the learning phase execution program 36 generates an ROI-enhanced learning image based on the designated ROI 121 (Step S022). Specifically, the learning phase execution program 36 performs image enhancement processing such as contrast enhancement processing or the like on the designated ROI 121 to generate an ROI-enhanced learning image in which only the ROI 121 is enhanced. Note that in the example illustrated in FIG. 3, a set region 163 in which only the region 162 in which the learning image 120 is matched on the design data 160 is enhanced, is generated as an ROI-enhanced learning image. Note that the set region 163 may be set by the user via the UI 50, or may be set according to a predetermined rule.

Next, the learning phase execution program 36 performs the machine learning of the ROI-enhanced engine 31 using the learning image 120 and the ROI-enhanced learning image (Step S023). Specifically, when the learning image 120 is input, the learning phase execution program 36 performs machine learning for optimizing the internal parameter of the ROI-enhanced engine 31 so that the generated ROI-enhanced learning image is output.

Note that in the learning phase, the machine learning of the ROI-enhanced engine 31 is performed by repeatedly executing the processing of Steps S10 to S23 using multiple (e.g., 10 to 100) learning images. Further, even in an ROI-enhanced engine 31 described in each embodiment to be described later, the machine learning is assumed to be executed by performing the learning phase plural times.

Next, the image processing phase will be described. In the image processing phase, a processed image 140 which is obtained by capturing an object 130 is used to output an ROI-enhanced processed image in which only the ROI in the processed image 140 corresponding to the ROI 121 is enhanced. Note that, for example, in the case where the user outputs an instruction to execute the image processing phase to the processor system 100 via the UI 50, etc., the image processing phase is started at a predetermined timing.

When the image processing phase is started, the processor system 100 executes the image processing phase execution program 37. The image processing phase execution program 37 acquires the processed image (the image of the object 130 corresponding to the set region 163 on the design data in the example of FIG. 3) which is obtained by capturing the object 130 from the processed image DB (Step S30). Note that the image processing phase execution program 37 may output an instruction to capture the processed image of the object 130 to the imaging device 10 via the NI 40 and acquire a processed image of an object imaged by the imaging device 10 from the processed image DB 33.

Next, the image processing phase execution program 37 acquires a ROI-enhanced processed image in which only the ROI is enhanced, using the ROI-enhanced engine 31 (Step S40). Specifically, when the processed image 140 is input by the image processing phase execution program 37, the ROI-enhanced engine 31 specifies an ROI corresponding to the ROI learned in the learning phase (the region 121 in the example of FIG. 3) from the processed image (Step S41).

Further, the ROI-enhanced engine 31 performs image processing of enhancing only the specified ROI to generate an ROI-enhanced processed image 150 (Step S42). In addition, the image processing phase execution program 37 acquires the ROI-enhanced processed image 150 output from the ROI-enhanced engine 31. Note that in the example illustrated in FIG. 3, an ROI-enhanced processed image 150 in which only the ROI corresponding to the ROI 121 in the region 162 is enhanced in the image (processed image) of the object 130 corresponding to the set region 163 on the design data is output.

Thus, according to the present system 100, it is possible to acquire the ROI-enhanced processed image having improved only ROI visibility by performing image processing so that only the region of interest (ROI) is enhanced and displayed according to the purpose of image analysis of the object. As a result, it is possible to perform the image analysis of the object more appropriately.

In particular, when the matching method based on the design data is used as the ROI designation method, the learning image can be automatically matched on the design data, so that the machine learning of the ROI-enhanced engine 31 using a plurality of learning images can be efficiently and easily performed.

Further, when the processed image is input to the ROI-enhanced engine 31 having conducted such machine learning, the ROI is not easily influenced by the deviations of the imaging range and position of the object, etc., and is specified from the processed image with high accuracy, whereby a ROI-enhanced processed image in which only the ROI is enhanced is generated.

Next, regarding the designation of the ROI in Step S21, a method in which the user uses a GUI to designate an ROI, the type of image enhancement processing, and the degree of image enhancement in a learning image (ROI designation method corresponding to B1 described above) will be described.

As described above, since the objects of ROI are various, it is required to be able to designate the ROI with a high degree of freedom depending on the purpose. Further, as examples of the type of image enhancement processing, the contrast enhancement processing, the histogram flattening processing, and the contour enhancement processing are given, but it is desirable to be able to designate the type of these with a high degree of freedom depending on the purpose. Further, depending on the purpose of image analysis, it may be better to have a weaker degree of image enhancement, or to have a stronger degree of image enhancement. Therefore, it is desirable to be able to designate the degree of the image enhancement with a high degree of freedom.

Therefore, in a method of designating an ROI to be described later, the user designates the ROI, the type of image enhancement processing, and the degree of image enhancement via the GUI. This makes it possible to obtain an ROI-enhanced processed image corresponding to the purpose of the image analysis of the object.

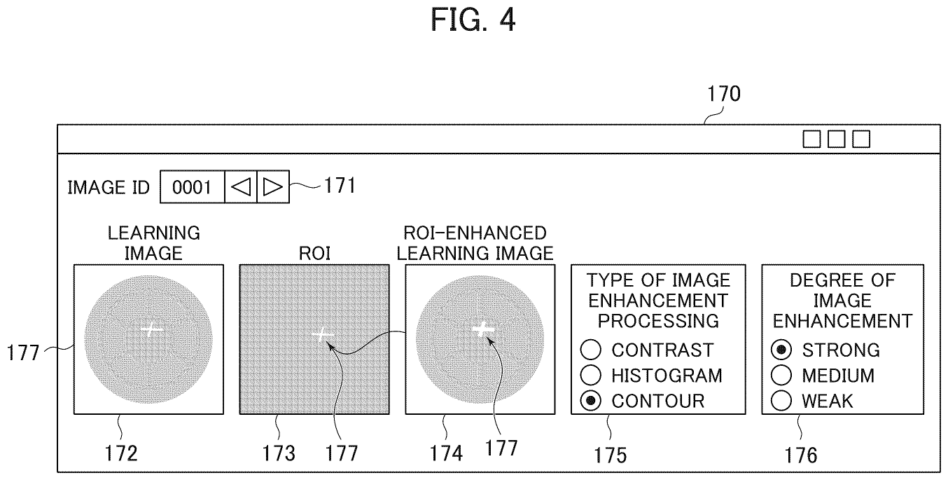

FIG. 4 is a view illustrating an example of a GUI 170 to designate an ROI, the type of image enhancement processing, and the degree of image enhancement. As illustrated in the drawing, there are displayed on the GUI 170, an image ID selection button 171 which selects a learning image, a region 172 on which the selected learning image is displayed, a region 173 on which an ROI designated by the user via the GUI is displayed, a region 174 on which an ROI-enhanced learning image in which only the ROI is enhanced is displayed, a region 175 which designates the type of image enhancement processing, and a region 176 which designates the degree of image enhancement.

Upon displaying such a GUI, the processor 20 reads the GUI execution program 35. Then, the GUI execution program 35 generates the predetermined GUI 170 illustrated in FIG. 4 and outputs the same to the UI 50 as the display.

Further, the GUI execution program 35 accepts the designations from the user regarding the ROI, the type of image enhancement processing, and the degree of image enhancement via the GUI 170 displayed on the display. Note that the user uses the UI 50 being the pointing device such as the keyboard or the mouse to select, for example, an image ID of a learning image. When input information indicative of the image ID is acquired, the GUI execution program 35 acquires a learning image of a corresponding ID from the learning image DB 32 and displays the same on the region 172 of the GUI 170 (Step S10).

Further, when the user uses the UI 50 to select a location 177 to be designated as an ROI in the learning image displayed on the GUI 170 (tracing the portion 177, surrounding it with a frame of a rectangle or the like in the example of FIG. 4, etc.), the GUI execution program 35 displays the designated ROI 177 on the region 173, based on such input information (Step S21). Note that in the example of FIG. 4, a while pixel part in the region 173 indicates the ROI designated by the user.

Further, when the user uses the UI 50 to designate the type of image enhancement processing and the degree of image enhancement displayed on the GUI 170, the learning phase execution program 36 acquires such input information via the GUI execution program 35 and generates an ROI-enhanced learning image by performing image enhancement processing with the designated degree of image enhancement and the designated type for the ROI 177 (Step S22). In addition, the GUI execution program 35 displays the ROI-enhanced learning image generated by the learning phase execution program 36 on the region 174 of the GUI.

Note that the learning phase execution program 36 performs the machine learning of the ROI-enhanced engine 31 using the ROI-enhanced learning image generated in this manner (Step S23).

Further, when the processed image is input to the ROI-enhanced engine 31 in which such machine leaning is performed in the image processing phase, an ROI-enhanced processed image is output in which image enhancement processing with the designated degree of image enhancement and the designated type is performed only on the ROI designated in the learning phase (Step S30, S40). That is, the ROI-enhanced processed image output via the image processing by the ROI-enhanced engine becomes one like the ROI-enhanced learning image displayed on the region 174 in FIG. 4, for example.

Note that since other processing in the learning phase and the image processing phase is similar to the above, the detailed description thereof will be omitted.

Thus, according to the present system 100, it is possible to designate the ROI, the type of image enhancement processing, and the degree of image enhancement using the GUI according to the purpose of image analysis with a high degree of freedom. Therefore, it is possible to obtain the ROI-enhanced processed image according to the purpose of the image analysis of the object.

Next, description will be made about the case in which machine learning is performed on a plurality of ROI-enhanced engines 31 to output mutually different ROI-enhanced processed images using the ROI-enhanced engines 31. The present system 100 performs machine learning of multiple ROI-enhanced engines 31 to output ROI-enhanced learning images different in at least either one of an ROI, the type of image enhancement processing, or the degree of image enhancement in the learning phase. Further, in the present system 100, in the image processing phase, the multiple ROI-enhanced engines 31 output ROI-enhanced processed images different in at least either one of the ROI, the type of image enhancement processing, or the degree of image enhancement.

As described above, upon the machine learning of each ROI-enhanced engine 31, it may be desirable to designate the ROI, the type of image enhancement processing, and the degree of image enhancement depending on the purpose. Further, in the image analysis of the object, it may be desirable to use an image to which multiple types of ROIs, types of image enhancement processing etc. are applied, rather than a single ROI, the type of image enhancement processing, etc.

Therefore, the present system 100 performs machine learning of a plurality of ROI-enhanced engines 31 to acquire multiple types of ROI-enhanced processed images different in at least either one of an ROI, the type of image enhancement processing, or the degree of image enhancement by using the ROI-enhanced engines 31.

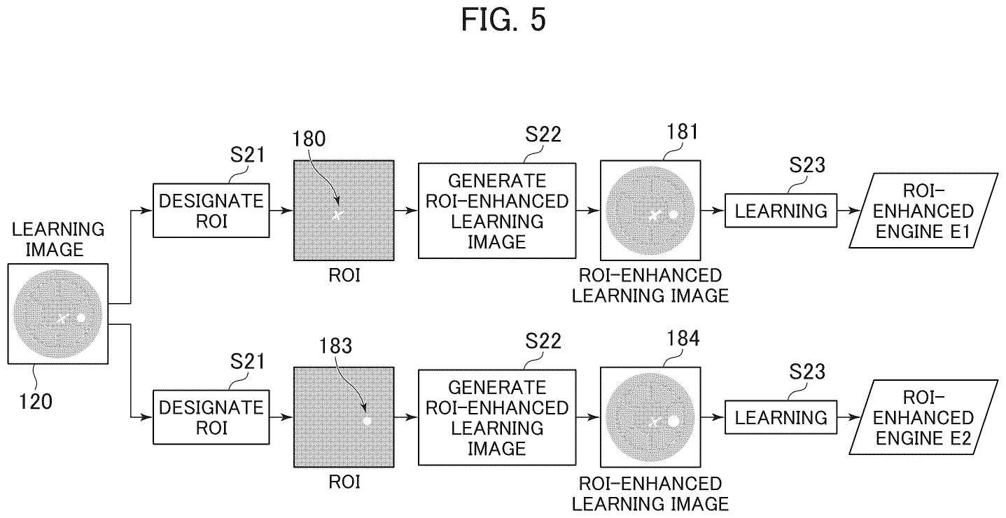

FIG. 5 is a view illustrating an example of a processing sequence of performing machine learning on two ROI-enhanced engines E1 and E2 in the learning phase. Regarding a learning image 120 acquired from the learning image DB 32, the learning phase execution program 36 accepts the designation of an ROI, and the designation of the type of image enhancement processing and the degree of image enhancement from the user via the GUI execution program 35 (Step S21). Further, the learning phase execution program 36 uses input information of the ROI and the like acquired via the GUI execution program 35 to generate an ROI-enhanced learning image (Step S22) and performs machine learning of the ROI-enhanced engines E1 and E2 using the learning image 120 and ROI-enhanced learning images 181 and 184 (Step S23).

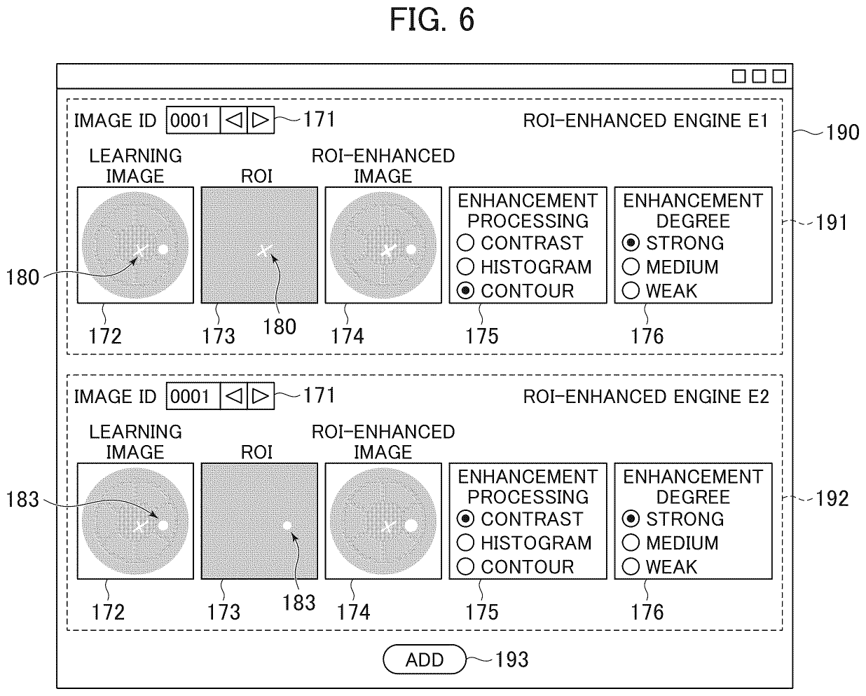

FIG. 6 is a view illustrating an example of a GUI 190 to designate an ROI, the type of image enhancement processing, and the degree of image enhancement. As illustrated in the figure, an upper stage 191 of the GUI is a region corresponding to the ROI-enhanced engine E1, and a lower stage 192 thereof is a region corresponding to the ROI-enhanced engine E2. Further, there is displayed in the GUI 190, an add button 193 which accepts depression when the ROI-enhanced engine that performs the machine learning is further added. Note that since the basic configuration of the GUI 190 illustrated in FIG. 6 is similar to the GUI 170 of FIG. 4, its detailed description will be omitted.

In the example illustrated in FIG. 6, the GUI execution program 35 accepts the designation of an ROI, the type of image enhancement processing, and the degree of image enhancement from the user (Step S21). Specifically, the GUI execution program 35 acquires input information to designate a part 180 of a learning image as an ROI, designate “contour” as the type of image enhancement processing, and designate “strong” as the degree of image enhancement with respect to the ROI-enhanced engine E1.

Also, the GUI execution program 35 acquires input information to designate a part 183 of a learning image as an ROI, designate “contrast” as the type of image enhancement processing, and designate “strong” as the degree of image enhancement with respect to the ROI-enhanced engine E2.

Further, the GUI execution program 35 displays the designated ROI in a region 172 corresponding to each of the ROI-enhanced engines E1 and E2, based on such input information.

In addition, the learning phase execution program 36 performs image enhancement processing with the designated degree of image enhancement and the designated type on the respective ROIs to generate ROI-enhanced learning images 181 and 184 corresponding to the ROI-enhanced engines E1 and E2 (Step S22). Moreover, the GUI execution program 35 displays the ROI-enhanced learning images 181 and 184 generated by the learning phase execution program 36 in regions 174 corresponding to the ROI-enhanced engines E1 and E2 of the GUI 190, respectively.

Note that the learning phase execution program 36 performs the machine learning of the ROI-enhanced engines E1 and E2 using the ROI-enhanced learning images 181 and 184 generated in this manner (Step S23). Specifically, when the learning image 120 is input, the learning phase execution program 36 performs the machine learning of the ROI-enhanced engine E1 so that the generated ROI-enhanced learning image 181 is generated. Likewise, when the learning image 120 is input, the learning phase execution program 36 performs the machine learning of the ROI-enhanced engine E2 so that the generated ROI-enhanced learning image 184 is generated.

Note that in the image processing phase, when the processed image is input to the ROI-enhanced engine E1, an ROI-enhanced processed image is output in which image enhancement processing of the designated type (“contour enhancement processing” in this case) with the designated degree of image enhancement (“strong” in this case) is performed only on the ROI designated in the learning phase.

Further, when the processed image is input to the ROI-enhanced engine E2, an ROI-enhanced processed image is output in which image enhancement processing of the designated type (“contrast enhancement processing” in this case) with the designated degree of image enhancement (“strong” in this case) is performed only on the ROI designated in the learning phase.

Thus, according to the present system 100, the multiple types of ROI-enhanced images can be obtained by applying the multiple types of ROIs, the type of image enhancement processing, and the degree of image enhancement, thereby making it possible to appropriately perform the image analysis of the object.

### Second Embodiment

A second embodiment will next be described. A system 100 according to the present embodiment generates a difference image using a learning non-defective item image and a learning defective item image in a learning phase and designates an ROI based on the difference image. Also, when an ROI-enhanced learning image in which the designated ROI is enhanced is generated, and the learning defective item image is input, the present system 100 performs machine learning of an ROI-enhanced engine 31 so that the ROI-enhanced learning image is output.

Further, in an image processing phase, the system according to the present embodiment inputs a processed image to the ROI-enhanced engine 31 to generate an image for comparison in which an ROI is enhanced, and compares the processed image and the comparison image to determine whether an object is a non-defective item or a defective item (non-defective/defective determination).

The conventional non-defective/defective determination has been made by visual judgement by an inspector in most external inspections using images. On the other hand, with increasing demands for mass production and quality improvement, inspection costs and the burden on the inspector are increasing. Further, sensory testing based on human senses requires a particularly high level of experience and skill, and additionally, issues also include individuality and reproducibility with evaluation values varying depending on the inspector and results varying each time the test is performed.

Automation for testing is strongly required to address issues such as the cost, skill, and individuality of such testing. Therefore, for example, if a defective portion is designated as an ROI by the method described in the first embodiment, an image in which a defect is enhanced is obtained, thereby enabling easier inspection.

On the other hand, when a user designates a defect using a GUI in the learning phase, a human burden is large. Particularly, when using a machine learning type engine as the ROI-enhanced engine 31, a large amount of learning images is generally required, so designating an ROI using a GUI for defects in all of the learning images would be a large time burden.

Therefore, the system according to the present embodiment provides a method of automatically designating an ROI (the designation method of the ROI corresponding to B2 described above) using a difference image calculated using a reference image being a learning non-defective item image and a learning defective item image.

Note that the same objects and processing as in the first embodiment are given the same reference numerals and their detailed description will be omitted.

### <Details of Learning Phase and Image Processing Phase>

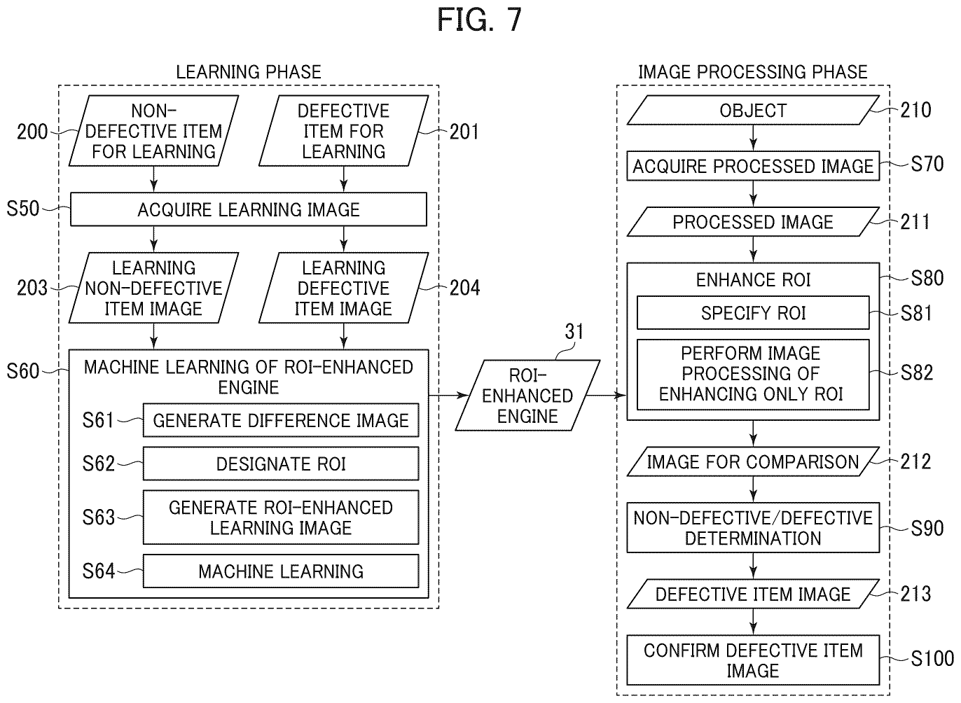

FIG. 7 is a view illustrating an example of a processing sequence of a learning phase and an image processing phase according to the present embodiment.

When the learning phase is started, the learning phase execution program 36 acquires a learning non-defective item image 203 and a learning defective item image 204 obtained by capturing a non-defective item for learning 200 and a defective item for learning 201 respectively, from the learning image DB 32 (Step S50).

Note that the learning phase execution program 36 may output an instruction to capture images of the learning non-defective item 200 and the learning defective item 201 to the imaging device 10 via the NI 40, and acquire the learning non-defective item image 203 and the learning defective item image 204 captured by the imaging device 10 from the learning image DB 32.

Next, the learning phase execution program 36 performs machine learning of the ROI-enhanced engine 31 using the learning non-defective item image 203 and the learning defective item image 204 (Step S60). Specifically, the learning phase execution program 36 designates an ROI being a portion of the learning defective item image 204 which is likely to be defective, with the learning non-defective item image 203 as the reference image.

Here, regarding the designation of the ROI, a method of taking a difference using a reference image and designating the ROI based on the value of the difference (the ROI designation method corresponding to B2 described above) will be described.

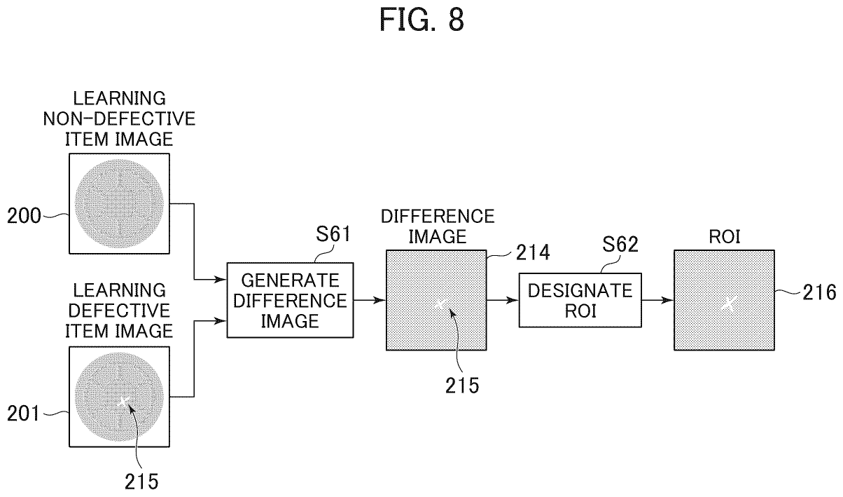

FIG. 8 is a view for describing a method of designating an ROI based on a difference from a reference image. The present method is for designating a region with a large difference from the learning non-defective item image as an ROI with a high possibility of being defective.

Specifically, the learning phase execution program 36 executes alignment between the learning non-defective item image 203 and the learning defective item image 204 to generate a difference image 214 between the learning non-defective item image 203 and the learning defective item image 204 with the learning non-defective item image 203 as the reference (Step S61). Further, the learning phase execution program 36 designates a region (a portion 215 of FIG. 8) in which a pixel value, i.e., difference value of the difference image 214 is greater than a preset threshold value, to an ROI 216.

Description will be returned to FIG. 7. Next, the learning phase execution program 36 generates an ROI-enhanced learning image based on the designated ROI 216 (Step S63). Specifically, the learning phase execution program 36 performs image enhancement processing such as contrast enhancement processing on the designated ROI 216 in the learning defective item image 204, to generate an ROI-enhanced learning image in which only the ROI 216 is enhanced.

Next, the learning phase execution program 36 performs machine learning of the ROI-enhanced engine 31 (Step S64). Specifically, when the learning defective item image 204 is input, the learning phase execution program 36 performs machine learning for optimizing an internal parameter of the ROI-enhanced engine 31 so that the generated ROI-enhanced learning image is output.

Next, the image processing phase will be described. In the image processing phase, an image for comparison (ROI-enhanced processed image) 212 is generated (estimated) from a processed image 211 captured of an object 210 to generate an image in which a region (ROI) with a high possibility of being defective is enhanced. Further, in the image processing phase, the processed image 211 and the image for comparison 212 are compared to determine whether or not the object is a non-defective item or a defective item.

When the image processing phase is started, the image processing phase execution program 37 acquires a processed image 211 captured of an object 210 to be inspected from the processed image DB 33 (Step S70).

Next, the image processing phase execution program 37 uses the ROI-enhanced engine 31 to acquire the image for comparison 212 being an ROI-enhanced processed image in which only an ROI is enhanced (Step S80). Specifically, when the processed image 211 is input to the ROI-enhanced engine 31 by the image processing phase execution program 37, the ROI-enhanced engine 31 specifies the ROI in the processed image (Step S81).

Further, the ROI-enhanced engine 31 performs image processing to enhance only the specified ROI to generate the image for comparison 212 being an ROI-enhanced processed image (Step S82), and outputs the same.

Next, the image processing phase execution program 37 uses the processed image 211 and the image for comparison 212 and compares both images to determine whether or not the object 210 to be inspected is a non-defective item or a defective item (non-defective/defective determination) (Step S90). Specifically, the image processing phase execution program 37 generates a difference image between the processed image 211 and the image for comparison 212 and determines the object to be defective when there is a location where the pixel value of the difference image is greater than a preset threshold value.

Note that when it is determined that the object 210 to be inspected is defective, the image processing phase execution program 37 may perform processing such as outputting the processed image (defective item image) 211 to a predetermined external device via, for example, the NI 40, and prompting an inspector to confirm the defective item image (Step S100), etc.

Thus, according to the present system 100, it is possible to automatically designate the ROI from the defective item image on the basis of the difference from the reference image and efficiently execute the machine learning of the ROI-enhanced engine. Further, according to the present system 100, it is possible to determine based on the difference between the processed image and the comparison image in which the ROI is enhanced, whether or not the object to be inspected is non-defective or defective. As a result, the automation of inspection can be achieved to address issues such as inspection costs, skills, and individual skills.

### Third Embodiment

Next, a third embodiment will be described. In a learning phase, a system according to the present embodiment generates a pseudo defective image by combining a pseudo defect with a learning non-defective item image, and designates a region into a pseudo defect is combined, as an ROI. Also, the present system 100 generates an ROI-enhanced learning image in which the ROI of the pseudo defective image is enhanced, and, when the pseudo defective image is input, performs the machine learning of the ROI-enhanced engine 31 so that the ROI-enhanced learning image is output.

Further, in an image processing phase, the system according to the present embodiment generates an image for comparison with the enhanced ROI by inputting a processed image to the ROI-enhanced engine 31 and determines whether or not an object is a non-defective item or a defective item (non-defective/defective determination), by comparison inspection of the processed image and the comparison image.

Although the system according to the second embodiment has performed the machine learning of the ROI-enhanced engine 31 and the like by using the learning defective item image, there is a problem in that collecting images of defective objects requires a large amount of cost.

Therefore, it is desirable to be able to perform the machine learning of the ROI-enhanced engine 31 using only the image of the non-defective item, to determine whether or not the object is a non-defective item or a defective item. Note that a neural network learning method is known which uses images of non-defective items and outputs an image of a non-defective item when an image of a defective item is input. However, this method has a problem in that even if an image of a non-defective item can be correctly output for defects such as scratches or color unevenness in which the brightness value of a defective portion is close to that of a non-defective item, a difference value is small in the comparative inspection between the image containing the defect and the non-defective item image, thereby making it difficult to detect defects with high accuracy.

Therefore, the system according to the present embodiment provides a method of designating an ROI based on a region in which a pseudo defect whose brightness value in a defective portion such as scratches or color unevenness is close to that of a non-defective item is combined through image processing (the ROI designation method corresponding to B5 described above).

Note that the same objects and processing as in the above-described embodiments are given the same reference numerals and their detailed description will be omitted.

### <Details of Learning Phase and Image Processing Phase>

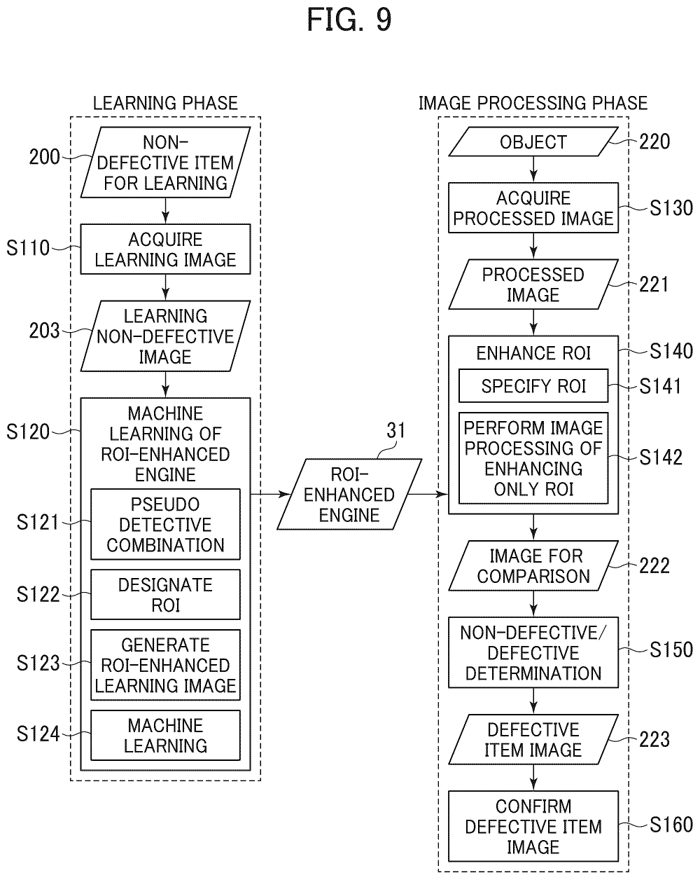

FIG. 9 is a view illustrating an example of a processing sequence of a learning phase and an image processing phase according to the present embodiment.

When the learning phase is started, the learning phase execution program 36 acquires a learning non-defective item image 203 obtained by capturing a learning non-defective item 200 from the learning image DB 32.

Next, the learning phase execution program 36 performs machine learning of the ROI-enhanced engine 31 (Step S120). Specifically, the learning phase execution program 36 combines a pseudo defect with the learning non-defective item image 203 (Step S121). More specifically, the learning phase execution program 36 combines a pseudo defect whose brightness value in a defective portion such as scratches or color unevenness is close to that of a non-defective item, with a learning non-defective item image.

Next, the learning phase execution program 36 designates a region in which a pseudo defect is combined, as an ROI (Step S122).

Here, regarding the designation of the ROI, a method of designating the ROI based on a region in which a pseudo defect whose brightness value in a defective portion such as scratches or color unevenness is close to that of a non-defective item is combined through image processing (the ROI designation method corresponding to B5 described above) will be described.

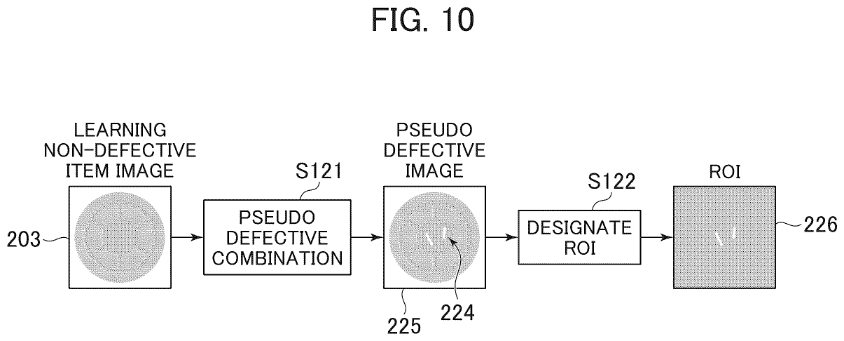

FIG. 10 is a view for describing a method of designating an ROI based on a region in which a pseudo defect is combined. The present method is for designating a region in which a pseudo defect is combined, as an ROI.

Specifically, the learning phase execution program 36 combines pseudo defects 224 at a predetermined position on a learning non-defective item image 203, whose brightness values in defective portions such as scratches and color unevenness are close to those non-defective items (Step S121) to generate a pseudo defective image 225. Further, the learning phase execution program 36 designates a region into which the pseudo defects 224 are combined, as an ROI 226 (Step S122)

Description will be returned to FIG. 9. Next, the learning phase execution program 36 generates an ROI-enhanced learning image based on the designated ROI 226 (Step S123). Specifically, the learning phase execution program 36 performs image enhancement processing such as contrast enhancement processing on the designated ROI 226, i.e., the portion of the synthesized pseudo defect 224 in the pseudo defective image 225 to generate an ROI-enhanced learning image in which only the ROI 226 is enhanced.

Next, the learning phase execution program 36 performs machine learning of the ROI-enhanced engine 31 (Step S124). Specifically, when the pseudo defective image 225 is input, the learning phase execution program 36 performs machine learning for optimizing an internal parameter of the ROI-enhanced engine 31 so that the generated ROI-enhanced learning image is output.

Next, the image processing phase will be described. In the image processing phase, an image for comparison (ROI-enhanced processed image) is generated (estimated) from a processed image, and the processed image and the comparison image are compared (inspected) to thereby determine whether or not an object is a non-defective item or a defective item. Note that since Steps S130, S140 to S142, and S160 are processing similar to Steps S70, S80 to S82, and S100 according to the second embodiment, their detailed description will be omitted.

In Step S150, the image processing phase execution program 37 uses a processed image 221 and a comparison image 222 and compares both images to judge (determine) whether or not an object 220 to be inspected is a non-defective item or a defective item.

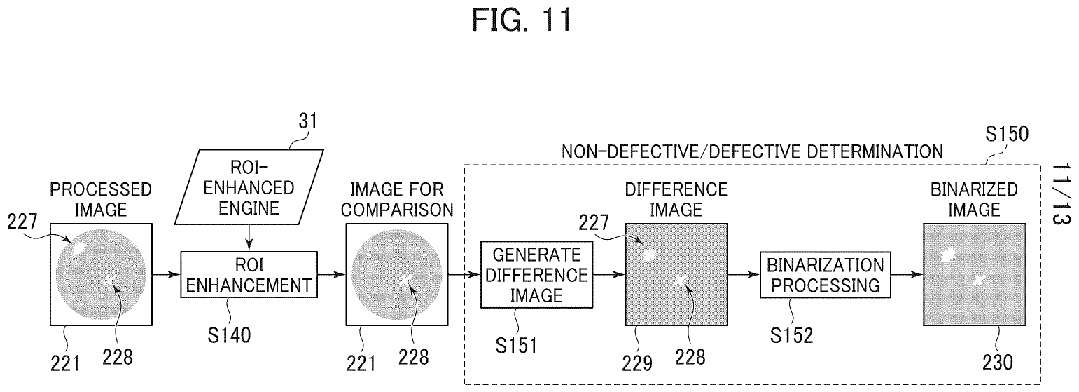

Here, the non-defective/defective determination of the object 220 to be inspected using the processed image 221 and the comparison image 222 will be described with reference to FIG. 11.

FIG. 11 is a view illustrating a processing sequence related to the non-defective/defective determination as to the object 220 to be inspected using the processed image 221 and the comparison image 222. As illustrated in the drawing, the processed image 221 acquired in Step S130 includes a portion 227 exhibiting a relatively large foreign matter or deficit, and a portion 228 exhibiting a defect such as scratches or color unevenness whose brightness value is close to that of a non-defective item.

Using such a processed image 221, the image processing phase execution program 37 generates a comparison image 222 which is an ROI-enhanced processed image. Specifically, the image processing phase execution program 37 inputs such a processed image 221 to the ROI-enhanced engine 31 to acquire an ROI-enhanced processed image output from the ROI-enhanced engine 31 and takes it as the comparison image 222.

Incidentally, since the ROI-enhanced engine 31 designates a defective region whose brightness value is close to that of a non-defective item, as an ROI to perform machine learning, an ROI-enhanced processed image (comparison image 222) in which only the defective region 228 whose brightness value in a defective portion such as scratches or color unevenness is close to that of a non-defective item is enhanced is output when the processed image 221 is input to such an ROI-enhanced engine 31. On the other hand, since an image such as the learning non-defective item image 203 is output for the region 227 of the relatively large defect such as the foreign matter or deficit, the comparison image 222 does not show any portion showing such foreign matter or the like.

Next, the image processing phase execution program 37 uses the processed image 221 and the comparison image 222 to compare both images, thereby judging (determining) whether or not the object 220 to be inspected is a non-defective item or a defective item. Specifically, the image processing phase execution program 37 generates a difference image 229 between the processed image 221 and the comparison image 222 (Step S151). Further, the image processing phase execution program 37 performs binarization processing on the difference image based on a threshold value set in advance (Step S152) to generate a binarized image 230.

Note that as illustrated in the drawing, since the difference image 229 is generated based on the difference between the processed image 221 and the comparison image 222, it includes the portion 227 exhibiting the foreign matter or deficit and the ROI 228 in which the defective portion such as the scratches or color unevenness whose brightness value is close to that of the non-defective item is enhanced. Further, when the binarization processing is performed on such a difference image 229, regions (the locations equivalent to the portion 227 exhibiting the foreign matter or the like and the ROI 228 in the example of FIG. 11) each being a region in which a pixel value is higher than a threshold value, are shown in white, and another region in which a pixel value is lower than the threshold value is shown in black.

The image processing phase execution program 37 refers to such a binarized image 230 and determines the object to be defective when the location in which the pixel value is larger than the threshold value set in advance, i.e., the portion shown in white is detected.

Thus, according to the present system 100, by performing the machine learning of the ROI-enhanced engine using the defective item image in which a pseudo defect whose brightness value at the defective portion such as the scratches or color unevenness is close to that of a non-defective item is combined, when the image containing the scratches or color unevenness is input to the ROI-enhanced engine, the present system outputs an ROI-enhanced processed image in which the region of the scratches or color unevenness is enhanced. Consequently, the present system 100 is capable of detecting a defect whose brightness value is close to that of the non-defective item through the inspection.

Further, for a non-defective portion in which a pseudo defect is not combined by the machine learning of the ROI-enhanced engine, the learning of the ROI-enhanced engine is performed to make the portion the same as the non-defective image. Therefore, when an image containing a relatively large defect such as a foreign matter or deficit is input to the ROI-enhanced engine during inspection, an image like a non-defective item without a defect is output as an ROI-enhanced processed image with respect to a region containing a foreign matter, a deficit, etc. On the other hand, the present system 100 generates a difference image using a processed image and an image for comparison and performs binarization processing on the difference image, to thereby make it possible to detect a relatively large defect such as a foreign matter or a deficit as well in the same way.

### Fourth Embodiment

Next, a fourth embodiment will be described. In a learning phase, a system 100 according to the present embodiment designates regions in which mutually different pseudo defects are combined, as ROIs, and performs machine learning of a plurality of ROI-enhanced engines 31 so that ROI-enhanced learning images mutually different in the type of image enhancement processing and the degree of image enhancement are output. Specifically, the present system 100 generates a plurality of pseudo defective images in which mutually different pseudo defects are combined with a learning non-defective item image, and designates regions in which pseudo defects are combined, as ROIs. Also, the present system 100 generates a plurality of ROI-enhanced learning images in which the ROI of each pseudo defective image is enhanced using mutually different types of image enhancement processing and degrees of image enhancement. Further, the present system 100 uses a plurality of ROI-enhanced engines 31 to perform machine learning of the ROI-enhanced engines 31 so that when a corresponding pseudo defective image is input for each ROI-enhanced engine 31, each corresponding ROI-enhanced learning image is output.

In addition, in an image processing phase, the system 100 according to the present embodiment inputs a processed image to the plurality of ROI-enhanced engines 31 to allow each ROI-enhanced engine 31 to output a comparison image with an enhanced ROI and compare the processed image and the plurality of comparison images output from each ROI-enhanced engine 31, thereby determining whether or not the object is a non-defective item or a defective item (non-defective/defective determination).

The third embodiment has described the method of, in the learning phase, applying the single ROI, the type of image enhancement processing, and the degree of image enhancement to the pseudo defective image to generate the ROI-enhanced learning image and performing the learning of the ROI-enhanced engine 31 using the pseudo defective image and the ROI-enhanced learning image. On the other hand, depending on the type of ROI, it may be possible to improve the accuracy of the inspection by using ROI-enhanced processed images that have been enhanced using the types of image enhancement processing not single but different from each other and the degree of image enhancement.

Therefore, the system according to the present embodiment performs machine learning of a plurality of ROI-enhanced engines 31 so as to output ROI-enhanced learning images mutually different in the ROI, the type of image enhancement processing, and the degree of image enhancement, and uses a plurality of types of ROI-enhanced processed images output by the ROI-enhanced engines 31 during inspection to thereby perform the non-defective/defective determination of the object with higher accuracy.

Note that the same objects and processing as in the above-described embodiments are given the same reference numerals and their detailed description will be omitted.

### <<Details of Learning Phase and Image Processing Phase>>

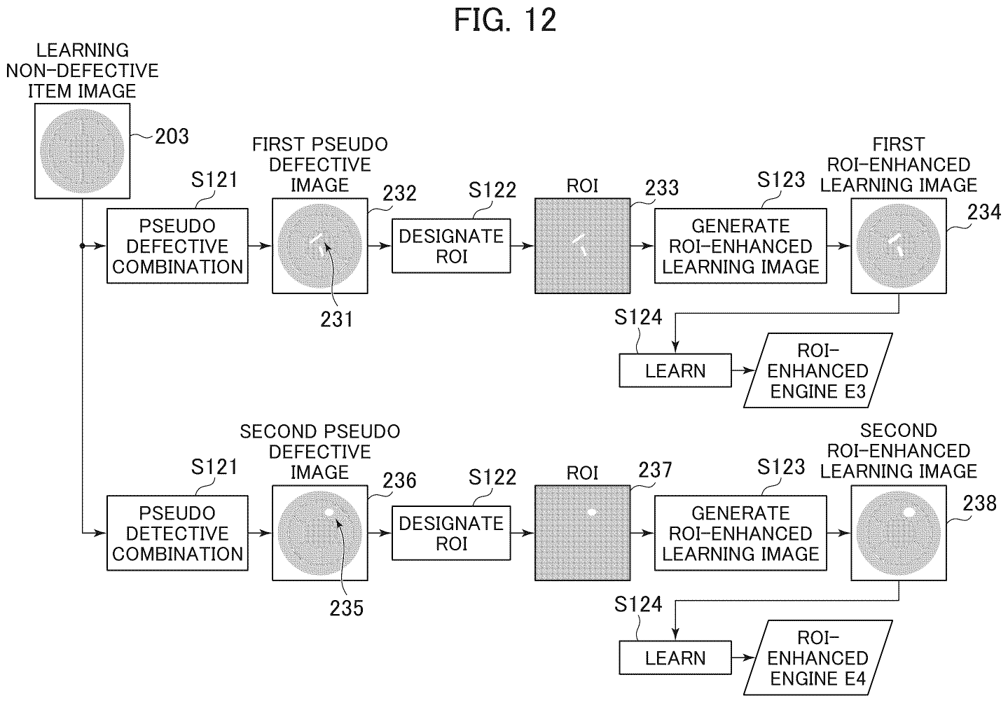

FIG. 12 is a view illustrating an example of a processing sequence of performing machine learning on two ROI-enhanced engines E3 and E4 in a learning phase. The learning phase execution program 36 acquires a learning non-defective item image 203 from the learning image DB 32 (Step S110), and combines a first pseudo defect 231 with such a learning non-defective item image (Steps S121), to thereby generate a first pseudo defective image 232. Also, the learning phase execution program 36 designates a region in which the first pseudo defect 231 is combined, as an ROI 233 (Step S122).

Further, the learning phase execution program 36 generates a first ROI-enhanced learning image 234 based on the designated ROI 233 (Step S123). Specifically, the learning phase execution program 36 performs image processing based on the type of first image enhancement and the degree of image enhancement to generate the first ROI-enhanced learning image 234 in which the ROI 233 is enhanced.

Next, the learning phase execution program 36 performs machine learning of the ROI-enhanced engine E3 so that the first ROI-enhanced learning image 234 is output with a first pseudo defective image 232 in which the first pseudo defect 231 is combined, as the input (Step S124).

Further, the learning phase execution program 36 performs machine learning of the ROI-enhanced engine E2 by a similar method. Specifically, the learning phase execution program 36 acquires a learning non-defective item image 203 from the learning image DB 32 (Step S110) and combines a second pseudo defect 235 different from the first pseudo defect with such a learning non-defective item image (Steps S121), to thereby generate a second pseudo defective image 236. Also, the learning phase execution program 36 designates a region in which the second pseudo defect 235 is combined, as an ROI 237 (Step S122).

Further, the learning phase execution program 36 generates a second ROI-enhanced learning image 238 based on the designated ROI 237 (Step S123). Specifically, the learning phase execution program 36 performs image processing based on the type of second image enhancement and the degree of image enhancement different from the type of first image enhancement and the degree of image enhancement to generate the second ROI-enhanced learning image 238 in which the ROI 237 is enhanced.

Next, the learning phase execution program 36 performs machine learning of the ROI-enhanced engine E4 so that the second ROI-enhanced learning image 238 is output with the second pseudo defective image 236 in which the second pseudo defect 235 is combined, as the input (Step S124).

Note that regarding the type of first image enhancement and the degree of image enhancement as described above, and the type of second image enhancement and the degree of image enhancement as described above, their designation may be accepted from the user using the GUI illustrated in FIG. 6, for example. Alternatively, those set in advance may be used therefor.

Next, the image processing phase will be described. In the image processing phase, each of the ROI-enhanced engines E3 and E4 generates (estimates) a comparison image (ROI-enhanced processed image) 222 from a processed image 221 and compares the processed image 221 and the comparison image 222 to determine whether or not an object 220 to be inspected is a non-defective item or a defective item. Note that such processing becomes processing similar to that in the image processing phase of the third embodiment.

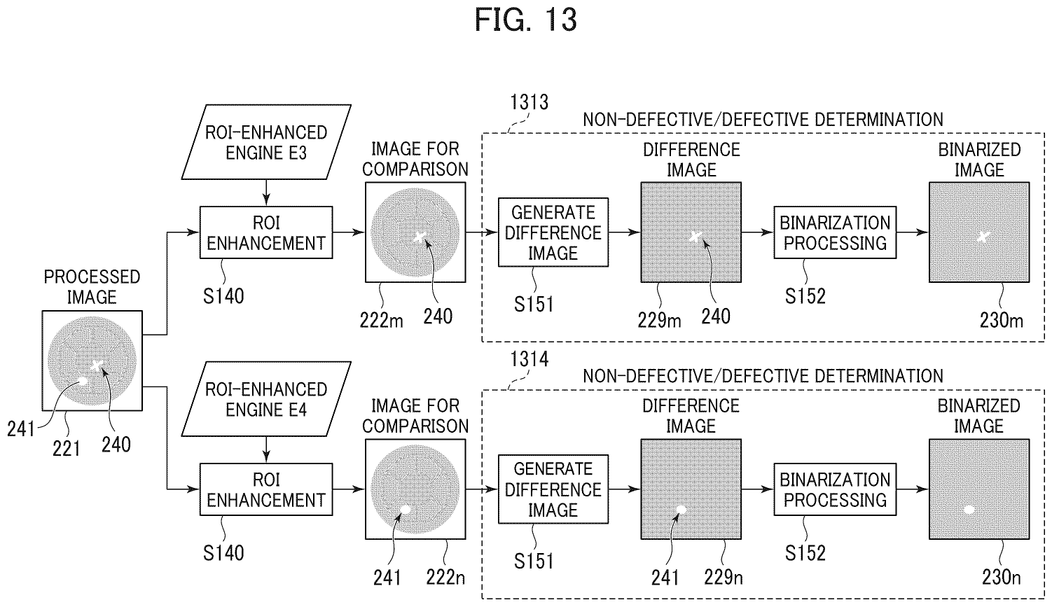

Here, a non-defective/defective determination as to the object 220 to be inspected using the processed image 221 and the comparison image 222 will be described with reference to FIG. 13.

FIG. 13 is a view illustrating a processing sequence related to the non-defective/defective determination as to the object 220 to be inspected using the processed image 221 and the comparison image 222. As illustrated in the drawing, the processed image 221 acquired in Step S130 includes a first defect 240 and a second defect 241. The image processing phase execution program 37 inputs the processed image 221 to the ROI-enhanced engine E3 to acquire an ROI-enhanced processed image in which only an ROI is enhanced (Step S140), and sets it as an image 222m for comparison.

Further, the image processing phase execution program 37 performs the non-defective/defective determination as to the object 220 using the processed image 221. Specifically, the image processing phase execution program 37 generates a difference image 229m between the processed image 221 and the comparison image 222m (Step S151) and performs binarization processing on the difference image based on a threshold value set in advance (Step S152), to thereby generate a binarized image 230m.

Note that the image processing phase execution program 37 performs processing similar to the processing using the ROI-enhanced engine E3 to generate a binarized image 230n using the ROI-enhanced engine E4.

Then, the image processing phase execution program 37 refers to such binarized images 230m and 230n and determines the object 220 to be defective when a portion larger than a preset threshold value, that is, a portion shown in white is detected in at least one binarized image. Note that since the processing of Step S160 is similar to the above, its detailed description will be omitted.

Thus, according to the present system 100, it is possible to conduct inspections for defects, etc. using a plurality of ROI-enhanced processed images generated depending on mutually different types of image enhancement and degrees of image enhancement. Therefore, according to the present system 100, it is possible to generate an appropriate ROI-enhanced processed image corresponding to the type of ROI, and improve the accuracy of inspection.

Note that the above-described embodiment includes both of the case where the same business operator executes the learning phase and the image processing phase using the processor system 100, and the case where the business operator executing only the learning phase and the business operator executing only the image processing phase (i.e., the phase of performing the image processing using the ROI-enhanced engine 31 after the machine learning) differ from each other.

Further, the present invention is not limited to the above-described embodiments and modifications, and includes various modifications within the scope of the same technical idea. For example, the above-described embodiments have been described in detail to explain the present invention in an easy-to-understand manner, and the present invention is not necessarily limited to having all the configurations described.

In addition, part of the configuration of one example can be replaced with the configurations of other examples, and in addition, the configuration of the one example can also be added with the configurations of other examples. For example, the ROI designation method in each embodiment may be used in different embodiments. Further, it is possible to perform addition, deletion, and replacement of another configurations with respect to part of the configuration of each embodiment.

In addition, in the above description, the control lines and information lines indicate those considered necessary for the explanation, and all control lines and information lines are not necessarily shown in the product. In reality, almost all configurations may be considered to be interconnected.

### LIST OF REFERENCE SIGNS

100: processor system, 20: processor, 30: memory resource, 31: ROI-enhanced engine, 32: learning image DB, 33: processed image DB, 34: another information DB, 35: GUI execution program, 36: learning phase execution program, 37: image processing phase execution program, 40: NI (Network Interface Device), 50: UI (User Interface Device), 10: imaging device

1. A system comprising:
at least one processor; and
at least one memory resource,
wherein the memory resource stores an ROI-enhanced engine and a learning phase execution program,
the processor executes the learning phase execution program to generate an ROI-enhanced learning image in which only an ROI (Region Of Interest) corresponding to an interested region of a processed image which is obtained by capturing an object for image processing is enhanced, using a learning image captured of an object for learning, and
when the learning image is input, the processor performs learning for optimizing an internal parameter of the ROI-enhanced engine so that the ROI-enhanced learning image is generated.

2. The system according to claim 1, wherein
the memory resource further stores an image processing phase execution program,
the processor executes the image processing phase execution program to input the processed image to the ROI-enhanced engine and acquire an ROI-enhanced processed image in which only the ROI is enhanced, which is output from the ROI-enhanced engine.

3. The system according to claim 1, wherein
the memory resource further stores a GUI execution program,
the processor executes the GUI execution program, to output screen information accepting the designation of the ROI in the learning image, the type of image enhancement processing and the degree of image enhancement both conducted on the ROI, in a learning phase of performing the learning of the ROI-enhanced engine, and
the processor executes a learning phase execution program to perform image enhancement processing with the designated degree of image enhancement and the designated type on the designated ROI, to generate the ROI-enhanced learning image.

4. The system according to claim 3, wherein
the processor executes the learning phase execution program to perform the learning on a plurality of the ROI-enhanced engines so as to output the ROI-enhanced learning images different in at least one of the ROI, the type of the image enhancement processing and the degree of the image enhancement.

5. The system according to claim 1, wherein
the processor executes the learning phase execution program to generate the ROI-enhanced learning image which is the learning image and in which the ROI designated based on a difference image between a learning non-defective item image which is obtained by capturing a learning non-defective item, and a learning defective item image which is obtained by capturing a learning defective item is enhanced.

6. The system according to claim 5, wherein
the memory resource further stores an image processing phase execution program, and
the processor executes the image processing phase execution program to determine whether or not the object is a non-defective item or a defective item, by comparison between the processed image and an image for comparison being an ROI-enhanced processed image in which only the ROI is enhanced, which is obtained by inputting the processed image to the ROI-enhanced engine.

7. The system according to claim 1, wherein
the processor executes the learning phase execution program, to generate the ROI-enhanced learning image which is the learning image and in which a region in which a pseudo defect is combined with a learning non-defective item image which is obtained by capturing a learning non-defective item is taken as the ROI.

8. The system according to claim 7, wherein
the memory resource further stores an image processing phase execution program, and
the processor executes the image processing phase execution program to determine whether or not the object is a non-defective item or a defective item, by comparison between the processed image and an image for comparison being an ROI-enhanced processed image in which only the ROI is enhanced, which is obtained by inputting the processed image to the ROI-enhanced engine.

9. The system according to claim 8, wherein
the processor executes the image processing phase execution program, to determine whether or not the object is a non-defective item or a defective item, using a binarized image generated by performing binarization processing on a difference image between the processed image and the comparison image.

10. The system according to claim 7, wherein
the processor executes the learning phase execution program, to designate a region in which the pseudo defects different from each other are combined, as the ROI, and perform the learning on a plurality of the ROI-enhanced engines so that the ROI-enhanced learning images mutually different in the type of image enhancement processing performed on the ROI and the degree of image enhancement performed on the ROI are output.

11. An image processing method performed by a system having at least one processor and at least one memory resource, comprising:
causing the processor to perform a step of generating, using a learning image which is obtained by capturing an object for learning, an ROI-enhanced learning image in which only an ROI (Region Of Interest) corresponding to an interested region of a processed image which is obtained by capturing an object for image processing is enhanced, and
causing the processor to perform a learning step for optimizing an internal parameter of an ROI-enhanced engine so that the ROI-enhanced learning image is generated when the learning image is input.

12. The image processing method according to claim 11, wherein
the processor further performs a step of inputting the processed image to the ROI-enhanced engine, and acquiring an ROI-enhanced processed image in which only the ROI is enhanced, which is output from the ROI-enhanced engine.

13. A program read from at least one memory resource and executed by at least one processor of a system having the processor and the memory resource, wherein
a learning phase execution program executed by the processor uses a learning image which is obtained by capturing an object for learning to generate an ROI-enhanced learning image in which only an ROI (Region Of Interest) corresponding to an interested region of a processed image which is obtained by capturing an object for image processing is enhanced, and
when the learning image is input, the learning phase execution program performs learning for optimizing an internal parameter of an ROI-enhanced engine so that the ROI-enhanced learning image is generated.

14. The program according to claim 13, wherein
an image processing phase execution program executed by the processor inputs the processed image to the ROI-enhanced engine to acquire an ROI-enhanced processed image in which only the ROI is enhanced, which is output from the ROI-enhanced engine.
